(19) United States
(12) Patent Application Publication
(10) Pub. No.: US 2013/0299249 A1
(43) Pub. Date: Nov. 14, 2013

(54) SUPER-ABRASIVE MATERIAL WITH ENHANCED ATTACHMENT REGION AND METHODS FOR FORMATION AND USE THEREOF

(71) Applicants: Gary E. Weaver, Conroe, TX (US); Ram L. Ladi, Tomball, TX (US)

(72) Inventors: Gary E. Weaver, Conroe, TX (US); Ram L. Ladi, Tomball, TX (US)

(21) Appl. No.: 13/466,807

(22) Filed: May 8, 2012

(51) Int. Cl. E21B 10/46; B01J 3/06; B24D 3/10

(52) U.S. Cl. 175/428; 51/307; 51/309; 51/297

(57) ABSTRACT

The disclosure provides a super-abrasive body including a thermally stable polycrystalline diamond (TSP) body having a top region and an enhanced attachment region, wherein the enhanced attachment region includes tungsten carbide particles having a volume of at least 30% of the total volume of the enhanced attachment region. The disclosure further provides a super-abrasive element having the super-abrasive body attached to a substrate via an attachment material located in or around the tungsten carbide particles. The disclosure additionally provides earth-boring drill bits with such a super-abrasive element. Further, the disclosure provides methods of forming such super-abrasive bodies and elements by forming a PCD body with particle of tungsten carbide in an enhanced attachment region, then leaching the PCD body and attaching it to a substrate via an attachment material in or around the tungsten carbide particles.

### TECHNICAL FIELD

The current disclosure relates to a super-abrasive body, such as a thermally stable polycrystalline diamond (TSP) body, having an enhanced attachment region containing tungsten carbide particles, such as eutectic tungsten carbide particles, for attachment of the TSP body to an attachment material, such as a metallurgical attachment material. The disclosure further relates to a super-abrasive element containing such a super-abrasive body attached to a substrate via tungsten carbide particles and an attachment material. Still other aspects of the disclosure relate to an industrial device containing such a super-abrasive element, such as an earth-boring drill bit or a machine tool. Further embodiments of the disclosure relates to methods of forming and using any of the above.

### BACKGROUND

Components of various industrial devices are often subjected to extreme conditions, such as high impact contact with abrasive surfaces. For example, such extreme conditions are commonly encountered during subterranean drilling for oil extraction or mining purposes. Diamond, with its unsurpassed wear resistance, is the most effective material for earth drilling and similar activities that subject components to extreme conditions. Diamond is exceptionally hard, conducts heat away from the point of contact with the abrasive surface, and may provide other benefits in such conditions.

Diamond in its polycrystalline form has added toughness as compared to single crystal diamond due to the random distribution of the diamond crystals, which avoids the particular planes of cleavage found in single diamond crystals. Therefore, polycrystalline diamond is frequently the preferred form of diamond in many drilling applications or other extreme conditions. Device elements have a longer usable life in these conditions if their surface layer is made of diamond, typically in the form of a polycrystalline diamond (PCD) compact, or another super abrasive material.

Elements for use in harsh conditions may contain a PCD layer bonded to a substrate. The manufacturing process for a traditional PCD is very exacting and expensive. The process is referred to as “growing” polycrystalline diamond directly onto a carbide substrate to form a polycrystalline diamond composite compact. The process involves placing a cemented carbide piece and diamond grains mixed with a catalyst binder into a container of a press and subjecting it to a press cycle using ultrahigh pressure and temperature conditions. The ultrahigh temperature and pressure are required for the small diamond grains to form into an integral polycrystalline diamond body. The resulting polycrystalline diamond body is also intimately bonded to the carbide piece, resulting in a composite compact in the form of a layer of polycrystalline diamond intimately bonded to a carbide substrate.

Cobalt and other metal catalyst/binder systems facilitate polycrystalline diamond growth. After crystalline growth is complete, the catalyst/binder remains within pores of the polycrystalline diamond body. Cobalt or other metal catalyst/binders have a larger coefficient of thermal expansion than diamond. As such, when the composite PCD is heated, e.g., during the brazing process by which the carbide portion is attached to another material, drilling, the metal catalyst/binder expands more quickly than the diamond. As a result, when the PCD is subjected to temperatures above a critical level, the expanding catalyst/binder can cause stress within the PCD and fractures can occur throughout the polycrystalline diamond structure. These fractures weaken the PCD and can ultimately lead to damage to or failure. PCD containing the catalyst/binder typically is not thermally stable at temperatures above 750° C. and may show deterioration due to thermal expansion of the binder/catalyst as well as from back conversion of diamond due to graphitization or oxidation at temperatures as low as 500° C.

Similar problems have been reported when substrate material, such as tungsten carbide, is intermixed with the PCD layer. For instance, U.S. Pat. No. 4,604,106 reports cracking even when a transition later including carbide is present between the PCD layer and the substrate on which it is formed.

As a result of these or other effects, it common to remove the catalyst from part of the PCD layer, particularly the parts near the working surface. PCD with catalyst removed is typically thermally stable up to temperatures around 1200° C.

The most common process for catalyst removal uses a strong acid bath, although other processes that employ alternative acids or electrolytic and liquid metal techniques also exist. In general, removal of the catalyst from the PCD layer using an acid-based method is referred to as leaching. Acid-based leaching typically occurs first at the outer surface of the PCD layer and proceeds inward. Thus, traditional elements containing a leached PCD layer are often characterized as being leached to a certain depth from their surface. PCD, including regions of the PCD layer, from which a substantial portion of the catalyst has been leached is referred to as TSP. Examples of current leaching methods are provided in U.S. Pat. No. 4,224,380; U.S. Pat. No. 7,712,553; U.S. Pat. No. 6,544,308; U.S. 20060060392 and related patents or applications.

Acid-leaching leaching must also be controlled to avoid contact between substrate or the interface between the substrate and the diamond layer and the acids used for leaching. Acids sufficient to leach polycrystalline diamond may severely degrade the much less resistant substrate. Damage to the substrate undermines the physical integrity of the PCD element and may cause it to crack, fall apart, or suffer other physical failure while in use, which may also cause other damage. Furthermore, removal of Co from the interface of the substrate and PCD layer weakens the bond between the PCD layer and the substrate, which may also result in failure of the PCD element during use.

The need to carefully control leaching of elements containing a PCD layer significantly adds to the complications, time, and expense of PCD manufacturing. Additionally, leaching is typically performed on batches of PCD elements. Testing to ensure proper leaching can be destructive or non-destructive. Destructive testing further adds to PCD element manufacturing costs.

Attempts have been made to avoid the problems of leaching a fully formed element by separately leaching a PCD layer, then attaching it to a substrate. However, these attempts have failed to produce usable elements. In particular, the methods of attaching the PCD layer to the substrate have failed during actual use, allowing the PCD layer to slip or detach. For example, elements produced using brazing methods, such as those described in U.S. Pat. No. 4,850,523; U.S. Pat. No. 7,487,849, U.S. Pat. No. 6,054,693, and SPE 90845 “Thermally Stable Polycrystalline Diamond Cutters for Drill Bits” and related patents, applications, or publications, or mechanical locking methods such as those described in U.S. Pat. No. 7,533,740 or U.S. Pat. No. 4,629,373 and related patents or applications are prone to failure.

Other methods of bonding a PCD layer to a pre-formed substrate are described in U.S. Pat. No. 7,845,438, but require melting of a material already present in the substrate and infiltration of the PCD layer by the material.

In still other methods, leached PCD layers have been attached directly to the gage region of a bit by infiltrating the entire bit and at least a portion of the PCD layer with a binder material. Although these methods are suitable for attaching PCD to a gage region, where it need not be removed during the lifetime of the bit, they are not suitable for placing PCD layers in the cutting regions of a bit, where replacement or rotation of the PCD is desirable for providing normal bit life.

Using still other methods, PCD elements, often referred to as geosets, have been incorporated into the exterior portions of drill bits. Geosets are typically coated with a metal, such as nickel (Ni). Geoset coatings may provide various benefits, such as protection of the diamond at higher temperature and improved bonding to the drill bit matrix.

Certain methods attempt to approach the problem by first forming a compact of abrasive particles with particle-to-particle bonds using a non-catalyst sintering aid during a press cycle, removing a metallic by-product of this sintering aid to form a network of interstices, then filling these interstices with a carbide by-product of the non-catalyst sintering aid to form a solid body. This body is then attached to a substrate by bonding both the particles and the carbide by-product to the substrate during a second press cycle. Like the other attachment methods described above, this method suffers from technical difficulties in obtaining a stable attachment.

Accordingly, a need exists for an element, including a rotatable or replaceable element, having a leached PCD layer, such as a TSP body, attached to a base or substrate sufficiently well to allow use of the element in high temperature conditions such as those encountered by cutting elements of an earth-boring drill bit.

### SUMMARY

The present disclosure, according to one embodiment, provides a super-abrasive body including a TSP body having a top region and an enhanced attachment region, wherein the enhanced attachment region includes tungsten carbide particles having a volume of at least 30% of the total volume of the enhanced attachment region.

According to another embodiment, the present disclosure provides a super-abrasive element comprising including a TSP body having a top region and an enhanced attachment region, wherein the enhanced attachment region includes tungsten carbide particles having a volume of at least 30% of the total volume of the enhanced attachment region, a substrate to which the TSP body is attached, and an attachment material disposed in the substrate and in or around the tungsten carbide particles of the enhanced attachment region of the TSP body.

According to a further embodiment, the disclosure provides an earth-boring drill bit including such a super-abrasive element as described above.

According to still another embodiment, the disclosure provides a method of forming a super-abrasive body by forming a PCD element by placing grains of diamond crystal, a catalyst, and tungsten carbide particles under sufficient temperature and pressure to form a diamond body matrix and an interstitial matrix including the catalyst, wherein the tungsten carbide particles are located in a region to for an enhanced attachment region of the PCD element, then leaching at least 85% of the catalyst and tungsten carbide from the PCD to form TSP having tungsten carbide particles, said tungsten carbide particles located in the enhanced attachment region of the PCD element, wherein the volume of the tungsten carbide particles comprises at least 30% of the total volume of the enhanced attachment region.

According to yet another embodiment, the disclosure provides a method of forming a super-abrasive element by forming a PCD element by placing grains of diamond crystal, a catalyst, and tungsten carbide particles under sufficient temperature and pressure to form a diamond body matrix and an interstitial matrix including the catalyst, wherein the tungsten carbide particles are located in a region to form an enhanced attachment region of the PCD element, leaching at least 85% of the catalyst from the PCD to form TSP having tungsten carbide particles, said tungsten carbide particles located in the enhanced attachment region of the PCD element, wherein the volume of the tungsten carbide particles comprise at least 30% of the total volume of the enhanced attachment region, and then metallurgically or micromechanically attaching the TSP to a substrate by disposing an attachment material in or around the tungsten carbide particles.

### BRIEF DESCRIPTION OF THE DRAWINGS

A more complete understanding of the present embodiments and advantages thereof may be acquired by referring to the following description taken in conjunction with the accompanying drawings, which depict embodiments of the present disclosure, and in which like numbers refer to similar components, and in which:

FIG. 1 is a cross-sectional side view of a super-abrasive body having an enhanced attachment region;

FIG. 2 is a magnified cross-sectional view of a super-abrasive body with tungsten carbide particles in the enhanced attachment region prior to leaching and attached to the formation substrate;

FIG. 3 is a cross-sectional side view of a super-abrasive element having a super-abrasive body with an enhanced attachment region.

### DETAILED DESCRIPTION

The current disclosure relates to a super-abrasive body, such as a TSP body, having an enhanced attachment region. The enhanced attachment region, according to one embodiment, may contain tungsten carbide particles. The an attachment material may infiltrate in or around the tungsten carbide particles to form an attachment, such as a metallurgical attachment material, between the enhanced attachment region and a substrate. Accordingly, the disclosure also includes a super-abrasive element containing such a super-abrasive body attached to a substrate via an attachment material, an industrial device containing such a super-abrasive element, and methods of forming and using such super-abrasive bodies, super-abrasive elements, or devices.

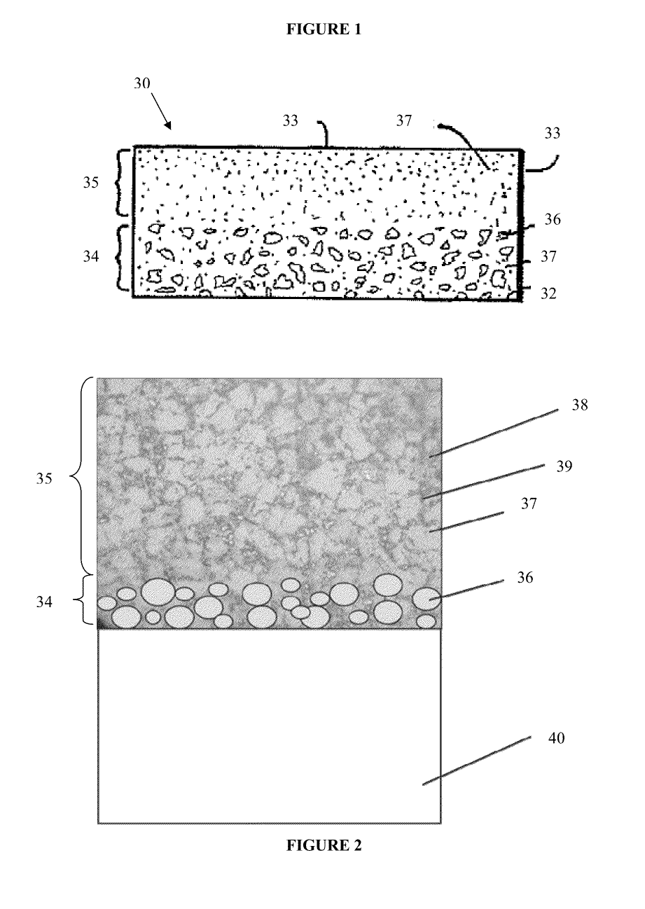

A super-abrasive body 30, as shown in FIG. 1, may include working surface 33 adjacent to top region 35, which is adjacent to enhanced attachment region 34, adjacent to attachment interface 32. Working surface 33 and top region 35 may include super-abrasive material 37. Enhanced attachment region 34 and attachment interface 32 may include super-abrasive material 37 as well as tungsten carbide particles 36.

Super-abrasive body 30 may, in one embodiment, include TSP. TSP may include any PCD that is leached sufficiently to exhibit thermal stability at temperatures above 750° C. For instance, according to some embodiments, at least 85% of catalyst may be removed from the TSP. In other embodiments, at least 90%, at least 95%, or even at least 99% of catalyst may be removed. In embodiments where super-abrasive element 30 includes TSP, super-abrasive material 37 may include diamond. According to alternative embodiments, super-abrasive element 30 may be formed from an alternative super-hard material 37, such as cubic boron nitride, or a single phase polycrystalline dense and superhard diamond formed from direct conversion from graphite under ultrahigh pressure and high temperature, as described in “Microstructure and Mechanical Properties of High-Hardness Nano-Polycrystalline Diamonds,” SEI Technical Review No. 66, p. 85 (April, 2008).

Tungsten carbide particles 36 in enhanced attachment region 34 may facilitate attachment of the TSP to a substrate by allowing attachment material to be present in or around the tungsten carbide particles. In particular, the tungsten carbide particles may facilitate the formation of a metallurgical bond or a micromechanical between the super-abrasive body and a substrate via an attachment material.

In some embodiments, the volume of tungsten carbide particles 36 may be at least 30%, at least 40%, or at least 50% of the volume of enhanced attachment region 34. In other embodiments, the tungsten carbide particles may have an average diameter of approximately 20 μm-250 μm. The average diameter of all tungsten carbide particles may be similar, or it may vary. Tungsten carbide particles may be roughly spherical or they may have irregular or other regular shapes.

In certain embodiments where super-abrasive body 30 includes TSP and super-hard material 37 is diamond, the diamond may have a uniform grain size. However, in other embodiments, the grain size may vary within the super-abrasive body. For instance, grain size at the top region or working surface may be selected to confer beneficial hardness, impact resistance, or other properties to the super-abrasive body. Grain size in the enhanced attachment region may be selected to facilitate movement of the attachment material into the enhanced attachment region, or to provide structural integrity to the enhanced attachment region during its formation, during removal of the catalyst, during infiltration by an attachment material, or during use of the super-hard body. In one embodiment, fine-grain diamond may be used near the working surface to confer greater wear resistance, while larger-grain diamond may be used in the enhanced attachment region to increase porosity.

According to an alternative embodiment, not shown, tungsten carbide particles 36 may instead be pores formed when a leaching-removable material is removed from enhanced attachment region 34 during a leaching process.

According to another embodiment, the disclosure relates to a method of forming a super-abrasive body, such as a super-abrasive body as described above. In one embodiment, this method may include forming a PCD body by combining grains of natural or synthetic diamond crystal with a catalyst and by placing tungsten carbide particles in a region to form the enhanced attachment region and then subjecting the mixture to high temperature and pressure to form a PCD attached to or separate from a formation substrate. An example embodiment in which the PCD is attached to the formation substrate is shown in FIG. 2.

In FIG. 2, the PCD may contain a super-hard material, 37, such as a diamond body matrix, an interstitial matrix containing the catalyst 38 and pores 39, and tungsten carbide particles 36 in the region to form the enhanced attachment region 34. The region to form the enhanced attachment region 34, in many embodiments, may be adjacent the formation substrate 40, but need not necessarily be in such a location. Furthermore, as compared to traditional PCD formation processes, the amount of formation substrate 40 present may be far less or the formation substrate may even be absent (not shown) because it will be removed in later processing. This allows for further optimization of pressing methods.

According to particular embodiments, the catalyst may include a Group VIII metal, particularly cobalt (Co). However, alternative catalysts may be used in some embodiments. Such catalysts include carbonates of Mg, Ca, Sr, Ba and combinations thereof. PCD materials formed with alternative catalysts are described Japanese Laid-Open publications Nos. 74766/1992 and 114966/1992, the material parts of which are incorporated by reference herein.

The tungsten carbide particles may include WC and W₂C. The particles may be of a size and an amount sufficient to obtain the desired volume of tungsten carbide as described above in the enhanced attachment region or otherwise to facilitate interactions with the attachment material and attachment of the TSP body to a substrate. The tungsten carbide particles may be formed from any type of tungsten carbide able to withstand leaching of the TSP body and remain sufficiently intact to facilitate attachment of the TSP body to a substrate via an attachment material. According to a specific embodiment, they may include eutectic tungsten carbide. FIG. 2 provides an example photomicrograph showing a TSP body containing spherical eutectic WC/W₂C particles (Witeam Commercial (Intl.), Ltd., Hong Kong).

The PCD may then be leached by any process able to remove the catalyst 38 from the interstitial matrix. The leaching process may also remove the formation substrate 40, if any is present. In some embodiments, at least a portion of the formation substrate may be removed prior to leaching, for example by grinding. In particular embodiments, the PCD may be leached using an acid. The leaching process may differ from traditional leaching processes in that there is no need to protect any substrate or boundary regions from leaching. For example, it may be possible to simply place the PCD or PCD/formation substrate combination into an acid bath with none of the protective components typically employed. Even the design of the acid bath may differ from traditional acid baths. In many processes for use with the present disclosure a simple vat of acid may be used.

An alternative leaching method using a Lewis acid-based leaching agent may also be employed. In such a method, the PCD containing catalyst may be placed in the Lewis acid-based leaching agent until the desired amount of catalyst has been removed. This method may be conducted at lower temperature and pressure than traditional leaching methods. The Lewis acid-based leaching agent may include ferric chloride (FeCl₃), cupric chloride (CuCl₂), and optionally hydrochloric acid (HCl), or nitric acid (HNO₃), solutions thereof, and combinations thereof. An example of such a leaching method may be found in U.S. Ser. No. 13/168,733 by Ram Ladi et al., filed Jun. 24, 2011, and titled “CHEMICAL AGENTS FOR LEACHING POLYCRYSTALLINE DIAMOND ELEMENTS,” incorporated by reference in its entirety herein.

When the catalyst is removed from the interstitial matrix, a super-abrasive body 30 results containing tungsten carbide particles 36 in enhanced attachment region 34.

In an alternative embodiment where tungsten carbide particles 36 are instead pores remaining after a leaching-removable material is removed, then, prior to leaching, the pores may be filled with the leaching-removable material. Such material may include any material that may be wholly or partially removed by a leaching process, such as the leaching processes described above. In one example, it may be a type of tungsten carbide or other material suitable for use as a formation substrate. The leaching process may remove all of the leaching-removable material from enhanced attachment region 34 or it may remove only a portion of the material, such that the pores remain partially filled.

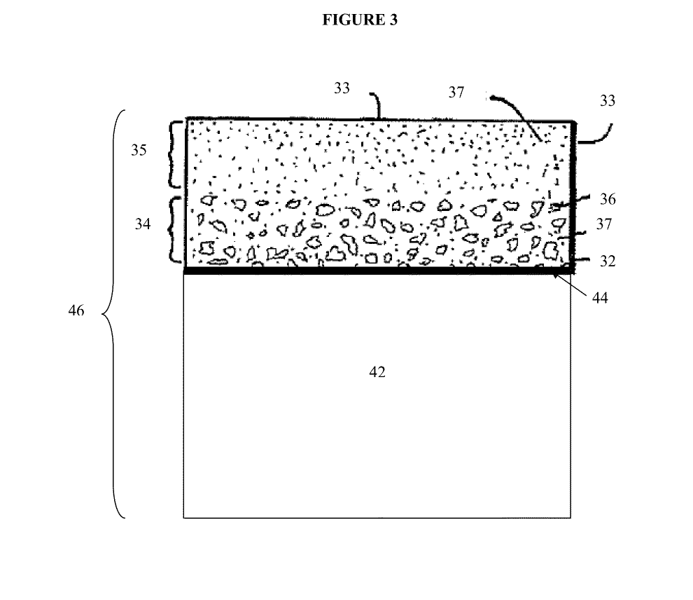

According to another embodiment, shown in FIG. 3, super-abrasive body 30 may be attached to a substrate, 42, via an attachment material, 38, at attachment interface 32, to form a super-abrasive element, 40. Attachment material 38 may be located in or around tungsten carbide particles 36 of the super-abrasive body 30 and may also infiltrate or bond to substrate 42. Substrate 42 may be a material able to facilitate attachment of super-abrasive element 40 to an industrial device, such as an earth-boring drill bit. For example, substrate 42 may include tungsten carbide. Substrate 42 may also be a portion of the industrial device itself (not shown).

According to specific embodiments, attachment material 38 may be able to form a metallurgical or micromechanical bond between substrate, 42 and super-abrasive body 30. Attachment material 38 may infiltrate tungsten carbide particles 36 or may simply be located around tungsten carbide particles 36, which may, for instance, improve infiltration of attachment material 38 in enhanced attachment region 34 due to their superior wetting properties as compared to diamond.

According to one specific embodiment, attachment material 38 may be a braze material such as a braze alloy composed of any materials able to form a braze joint between super-abrasive body 30 and substrate 42. In particular embodiments it may include a Group VIII metal, for example manganese (Mn) or chromium (Cr), a carbide, or titanium (Ti) alloyed with copper (Cu) or silver (Ag). According to another specific embodiment, attachment material 38 may include a welding material such as a weld alloy able to form a welded joint between super-abrasive body 30 and substrate 42.

According to an additional specific embodiment, the attachment material may include a material able to infiltrate the substrate, such as a catalyst used in PCD formation, such as a Group VIII metal, for example manganese (Mn) or chromium (Cr). It may also be a carbide or material used in the formation of carbide, such as titanium (Ti) alloyed with copper (Cu) or silver (Ag). It may further be an alloy, such as a nickel (Ni) alloy or another metal alloy, such as a Group VIII metal alloy. In certain embodiments, attachment material 38 may be a different material than was used as the catalyst during formation of the PCD later leached to form the TSP body. This allows easy detection of catalyst separate from binder. However, in other embodiments, the infiltrant material and catalyst may be the same. In embodiments using an infiltrant material as attachment material 38, substrate 42 may be formed on super-abrasive body 30, for example as described in U.S. Ser. No. 13/225,134, incorporated in material part by reference herein. In other embodiments, attachment material 38 may infiltrate a pre-formed substrate or a device to which super-abrasive body 30 is attached. Attachment material 38 may also be able to infiltrate tungsten carbide particles 36, but need not necessarily be able to do so, particularly if tungsten carbide particles 36 are formed from a different type of tungsten carbide than substrate 42.

Although attachment surface 32 is shown as a planar surface in FIG. 3, the present disclosure allows the attachment of a super-abrasive body to a substrate having other shapes, such as conical shapes or shapes not easily achieved with a traditionally leached super-abrasive element. In particular non-linear shapes and interstices may be appropriate.

Super-abrasive elements of the current disclosure may be in the form of any element that benefits from a super-abrasive surface, such as a TSP surface. In particular embodiments they may be cutters for earth-boring drill bits or components of industrial devices, such as tools. Further, although only a cylindrical-shaped super-abrasive body and element are illustrated in FIGS. 1 and 3, the present disclosure allows the formation of super-abrasive bodies and elements in a wider variety of shapes than are possible using traditional leaching methods due to the absence of any need to protect a substrate during leaching. For example, super-abrasive elements may be formed in any shape suitable for their ultimate use, such as, in some embodiments, a conical shape, a variation of a cylindrical shape, or even with angles. Additionally, the surface of the superabrasive elements in some embodiments may be concave, convex, or irregular.

According to a further embodiment, the disclosure provides a method of forming a super-abrasive element 40 including super-abrasive body 30 attached to substrate 42 via a metallurgical or micromechanical attachment using attachment material 38. During the process, attachment material 38 surround or infiltrates tungsten carbide particles 36 of the super-abrasive body. According to one embodiment, the process involves brazing or welding a super-abrasive body to a substrate. According to another embodiment, the process involves infiltrating the substrate with the attachment material. According to still another embodiment, the process involves forming a substrate on the super-abrasive element by infiltrating another material with the attachment material. In either infiltration process, tungsten carbide particles 36 may also be infiltrated by the attachment material.

Embodiments of the current disclosure also include tools containing super-abrasive elements of the disclosure. Specific embodiments include industrial tools and earth-boring drill bits, such as fixed cutter drill bits. Other specific embodiments include wear elements, bearings, or nozzles for high pressure fluids. In certain other embodiments, super abrasive elements of the current disclosure may be used in directing fluid flow or for erosion control in an earth-boring drill bit. For instance, they may be used in the place of abrasive structures described in U.S. Pat. No. 7,730,976; U.S. Pat. No. 6,510,906; or U.S. Pat. No. 6,843,333, each incorporated by reference herein in material part.

Due to the ability to remove catalyst from the super-abrasive body to a greater degree than in traditional processes where it is leached while bound to a substrate, super-abrasive elements of the current disclosure may be usable in conditions in which more elements with a traditional leached super-abrasive element are not. For instance, super-abrasive elements may be used at higher temperatures than similar elements leached in a traditional fashion.

According to alternative embodiments in which tungsten carbide particles 36 are instead pores, attachment material 38 may wholly or partially fill the pores to facilitate attachment of super-abrasive body 30 to substrate 42.

When super-abrasive elements of the current disclosure are used as cutters on earth-boring drill bits, they may be used in place of any traditional leached PCD cutter. In many embodiments, they may be attached to the bits via substrate 42. For instance, substrate 42 may be attached to a cavity in the bit via brazing. Super-abrasive bodies may also be attached directly to a bit, for example by direct attachment to the bit body instead of to substrate 42.

When used in cutting portions of a bit, the working surface of the cutter will wear more quickly than other portions of TSP body 30. When a circular cutter, such as that shown in FIG. 3 is used, the cutter may be rotated to move the worn TSP away from the working surface and to move unused TSP to the working surface. Circular cutters according to the present disclosure may be rotated in this fashion multiple times before they are too worn for further use. The methods of attachment and rotation may be any methods employed with traditional leached PCD cutters or other methods. Similarly, non-circular cutters may be indexable, allowing their movement to replace a worn working surface without replacing the entire cutter.

In addition to being rotatable, traditional PCD cutters may also be removed from a bit. This allows worn or broken cutters to be replaced or allows their replacement with different cutters more optimal for the rock formation being drilled. This ability to replace cutters greatly extends the usable life of the earth boring drill bit overall and allows it to be adapted for use in different rock formations. Cutters formed using super-abrasive elements according to this disclosure may also be removed and replaced using any methods employed with traditional leached PCD cutters.

Although only exemplary embodiments of the invention are specifically described above, it will be appreciated that modifications and variations of these examples are possible without departing from the spirit and intended scope of the invention. For example, other materials may be suitable, in particular, for super-abrasive element formed from super-hard materials other than diamond.

1. A super-abrasive body comprising a thermally stable polycrystalline diamond (TSP) body having a top region and an enhanced attachment region, wherein the enhanced attachment region comprises tungsten carbide particles having a volume of at least 30% of the total volume of the enhanced attachment region, and wherein the TSP body is formed from polycrystalline diamond (PCD) leached sufficiently to exhibit thermal stability at temperatures above 750° C.

2. The super-abrasive body according to claim 1, wherein the TSP body comprises polycrystalline diamond (PCD) containing diamond and catalyst from which at least 85% of the catalyst has been removed.

3. The super-abrasive body according to claim 1, wherein the TSP body comprises a FeCl₃-acid-leached TSP body.

4. The super-abrasive body according to claim 1, wherein the tungsten carbide particles comprise eutectic tungsten carbide.

5. A super-abrasive element comprising:
a thermally stable polycrystalline diamond (TSP) body having a top region and an enhanced attachment region, wherein the enhanced attachment region comprises tungsten carbide particles having a volume of at least 30% of the total volume of the enhanced attachment region;
a substrate to which the TSP body is attached; and
an attachment material disposed in or on the substrate and in or around the tungsten carbide particles of the enhanced attachment region of the TSP body, and
wherein the TSP body is formed from polycrystalline diamond (PCD) leached sufficiently to exhibit thermal stability at temperatures above 750° C.

6. The super-abrasive element according to claim 5, wherein the TSP body comprises polycrystalline diamond (PCD) containing diamond and catalyst from which at least 85% of the catalyst has been removed.

7. The super-abrasive element according to claim 5, wherein the TSP body comprises a FeCl₃-acid-leached TSP body.

8. The super-abrasive element according to claim 5, wherein the tungsten carbide particles comprise eutectic tungsten carbide.

9. The super-abrasive element according to claim 5, wherein the attachment material comprises a braze material.

10. The super-abrasive element according to claim 5, wherein the attachment material comprises a welding material.

11. The super-abrasive element according to claim 5, wherein the attachment material comprises an infiltrant material.

12. The super-abrasive element according to claim 5, wherein the substrate comprises tungsten carbide.

13. An earth-boring drill bit comprising:
a bit body; and
a super-abrasive element is mounted on the bit body, the super-abrasive element comprising:
a thermally stable polycrystalline diamond (TSP) body having a top region and an enhanced attachment region, wherein the enhanced attachment region comprises tungsten carbide particles having a volume of at least 30% of the total volume of the enhanced attachment region;
a substrate to which the TSP body is attached; and
an attachment material disposed in the substrate and in or around the tungsten carbide particles of the enhanced attachment region of the TSP body,
wherein the TSP body is formed from polycrystalline diamond (PCD) leached sufficiently to exhibit thermal stability at temperatures above 750° C.

14. The earth-boring drill bit according to claim 13, wherein the TSP body comprises polycrystalline diamond (PCD) containing diamond and catalyst from which at least 85% of the catalyst has been removed.

15. The earth-boring drill bit according to claim 13, wherein the TSP body comprises a FeCl₃-acid-leached TSP body.

16. The earth-boring drill bit according to claim 13, wherein the tungsten carbide particles comprise eutectic tungsten carbide.

17. The earth-boring drill bit according to claim 13, wherein the attachment material comprises a braze material.

18. The earth-boring drill bit according to claim 13, wherein the attachment material comprises a welding material.

19. The earth-boring drill bit according to claim 13, wherein the attachment material comprises an infiltrant material.

20. The earth-boring drill bit according to claim 13, wherein the substrate comprises tungsten carbide.

21. The earth-boring drill bit according to claim 13, wherein the substrate comprises the bit.

22. The earth-boring drill bit according to claim 13, wherein the super-abrasive element is in the form of a cutter.

23. The earth-boring drill bit according to claim 13, wherein the super-abrasive element is in the form of a wear elements.

24. The earth-boring drill bit according to claim 13, wherein the super-abrasive element is in the form of a bearing.

25. The earth-boring drill bit according to claim 13, wherein the super-abrasive element is in the form of a nozzle.

26. The earth-boring drill bit according to claim 13, wherein the super-abrasive element is in the form of a fluid flow or erosion control element.

27-31. (canceled)
